(19) United States
(12) Patent Application Publication
(10) Pub. No.: US 2026/0227314 A1
(43) Pub. Date: Aug. 6, 2026

(54) DYE DATA ACQUISITION METHOD, DYE DATA ACQUISITION DEVICE, AND DYE DATA ACQUISITION PROGRAM

(71) Applicant: HAMAMATSU PHOTONICS K.K., Hamamatsu-shi, Shizuoka (JP)

(72) Inventors: Takafumi HIGUCHI, Shizuoka (JP); Kenichiro IKEMURA, Shizuoka (JP); Yoshiaki YAMAUCHI, Shizuoka (JP); Kenta TSUJII, Shizuoka (JP); Koji TAKEMIYA, Shizuoka (JP); Yasumasa MATSUOKA, Shizuoka (JP)

(73) Assignee: HAMAMATSU PHOTONICS K.K., Hamamatsu-shi, Shizuoka (JP)

(21) Appl. No.: 19/157,992

(22) PCT Filed: Dec. 26, 2023
(86) PCT No.: PCT/JP2023/046650

§ 371 Date: Aug. 19, 2025

(30) Foreign Application Priority Data
Feb. 24, 2023 (JP) 2023-027533

(51) Int. Cl. G01N 15/1429; G01N 15/10

(52) U.S. Cl. CPC G01N 15/1429; G01N 2015/1006

(57) ABSTRACT

A data processing device clusters N (N is an integer of 2 or more) analytes into L (L is an integer of 2 or more and N-1 or less) target object groups based on the intensity values of each analyte for each of C (C is an integer of 2 or more) wavelength bands and generates L cluster matrices in which the intensity values for each of the C wavelength bands are arranged; calculates a statistical value of the intensity values of the target object groups in the C wavelength bands; and uses the statistical values in the C wavelength bands to perform unmixing with respect to the C wavelength bands, and generates K (K is an integer of 2 or more and C or less) pieces of dye data indicating a distribution for each of K fluorescent dyes.

### TECHNICAL FIELD

One aspect of an embodiment relates to a dye data acquisition method, a dye data acquisition device, and a dye data acquisition program.

### BACKGROUND ART

Conventionally, flow cytometry has been known as a technique for counting, sorting, and analyzing the characteristics of a sample such as a cell using laser light. For example, Patent Literature 1 below discloses clustering cells, for fluorescence data of each color light from cells output in a flow cytometer. In addition, Non-Patent Literature 2 below discloses that fluorescence data output from a flow cytometer is unmixed to generate a fluorescence spectrum for each fluorescent dye, and then clustering processing is executed on the fluorescence spectrum.

### CITATION LIST

### Patent Literature

Patent Literature 1: Japanese Unexamined Patent Publication No. 2020-87465
Patent Literature 2: Japanese Unexamined Patent Publication No. 2021-36224

### SUMMARY OF INVENTION

### Technical Problem

In the conventional technique as described above, it tends to be difficult to obtain a fluorescence spectrum with high accuracy when a mixing matrix used for unmixing is unknown. For example, it is difficult to obtain a fluorescence spectrum with high accuracy in a case where observation conditions change due to a change in a type of dye to be observed, a type of excitation light to be used, and the like.

Therefore, one aspect of the embodiment has been made in view of such a problem, and an object thereof is to provide a dye data acquisition method, a dye data acquisition device, and a dye data acquisition program capable of obtaining a fluorescence spectrum with high accuracy even in a case where observation conditions change.

### Solution to Problem

A dye data acquisition method according to a first aspect of the embodiment includes: a data acquisition step of acquiring spectrum data that is a distribution of fluorescence intensity values for each of C (C is an integer of 2 or more) detection wavelengths, for N (N is an integer of 2 or more) target objects; a clustering step of clustering the N target objects into L (L is an integer of 2 or more and N−1 or less) target object groups based on the intensity values of each target object for each of the C detection wavelengths, and generating L cluster matrices in which the intensity values for each of the C detection wavelengths are arranged for each clustered target object group; a calculation step of calculating a statistical value of the intensity values of the target object groups in the C detection wavelengths for each of the L cluster matrices; and a data generation step of using the statistical values in the C detection wavelengths for each of the L cluster matrices to perform unmixing with respect to the C detection wavelengths, and generating K (K is an integer of 2 or more and C or less) pieces of dye data indicating a distribution for each of K fluorescent dyes.

Alternatively, a dye data acquisition device according to a second aspect of the embodiment is a dye data acquisition device that processes spectrum data that is a distribution of fluorescence intensity values for each of C (C is an integer of 2 or more) detection wavelengths, for N (N is an integer of 2 or more) target objects, in which the dye data acquisition device is configured to: cluster the N target objects into L (L is an integer of 2 or more and N−1 or less) target object groups based on the intensity values of each target object for each of the C detection wavelengths, and generate L cluster matrices in which the intensity values for each of the C detection wavelengths are arranged for each clustered target object group; calculate a statistical value of the intensity values of the target object groups in the C detection wavelengths for each of the L cluster matrices; and use the statistical values in the C detection wavelengths for each of the L cluster matrices to perform unmixing with respect to the C detection wavelengths, and generate K (K is an integer of 2 or more and C or less) pieces of dye data indicating a distribution for each of K fluorescent dyes.

Alternatively, a dye data acquisition program according to a third aspect of the embodiment is a dye data acquisition program for generating dye data indicating a distribution of fluorescent dyes in N (N is an integer of 2 or more) target objects based on spectrum data that is a distribution of fluorescence intensity values for each of C (C is an integer of 2 or more) detection wavelengths, for the N target objects, the dye data acquisition program causing a computer to execute: a step of clustering the N target objects into L (L is an integer of 2 or more and N-1 or less) target object groups based on the intensity values of each target object for each of the C detection wavelengths, and generating L cluster matrices in which the intensity values for each of the C detection wavelengths are arranged for each clustered target object group; a step of calculating a statistical value of the intensity values of the target object groups in the C detection wavelengths for each of the L cluster matrices; and a step of using the statistical values in the C detection wavelengths for each of the L cluster matrices to perform unmixing with respect to the C detection wavelengths, and generating K (K is an integer of 2 or more and C or less) pieces of dye data indicating a distribution for each of K fluorescent dyes.

According to the first aspect, the second aspect, or the third aspect, spectrum data of a fluorescence distribution of C detection wavelengths is acquired for each of N target objects. This spectrum data is clustered into L target object groups, L cluster matrices in which the intensity values of the target object groups are arranged for each of the C detection wavelengths are generated, and the statistical values of the intensity values of the target object groups are calculated for each of the L cluster matrices. Furthermore, as a result of performing unmixing based on the statistical values of the L cluster matrices, K pieces of dye data indicating the distribution of the K fluorescent dyes for each of the target objects are generated. As a result, in a case where a type of dye to be observed, a type of excitation light used for observation, or the like changes, even in a case where a deviation in the number of each dye occurs, unmixing suitable for the observation conditions is executed, and dye data that is fluorescence spectrum data with high accuracy can be obtained.

A dye data acquisition method according to a fourth aspect of the embodiment includes: a data acquisition step of acquiring spectrum data that is a distribution of fluorescence intensity values for each of C (C is an integer of 2 or more) detection wavelengths, for N (N is an integer of 2 or more) target objects; a clustering step of clustering the C detection wavelengths into M (M is an integer of 2 or more and C−1 or less) detection wavelength groups based on the intensity values, for each of the N target objects, and generating M cluster matrices in which the intensity values for each of the N target objects are arranged for each clustered detection wavelength group; a calculation step of calculating a statistical value of the intensity values of the detection wavelength groups in the N target objects for each of the M cluster matrices; and a data generation step of using the statistical values in the N target objects for each of the M cluster matrices to perform unmixing with respect to the N target objects, and generating K (K is an integer of 2 or more and M or less) pieces of dye data indicating a distribution for each of K fluorescent dyes.

Alternatively, a dye data acquisition device according to a fifth aspect of the embodiment is a dye data acquisition device that processes spectrum data that is a distribution of fluorescence intensity values for each of C (C is an integer of 2 or more) detection wavelengths, for N (N is an integer of 2 or more) target objects, in which the dye data acquisition device is configured to: cluster the C detection wavelengths into M (M is an integer of 2 or more and C−1 or less) detection wavelength groups based on the intensity values, for each of the N target objects, and generate M cluster matrices in which the intensity values for each of the N target objects are arranged for each clustered detection wavelength group; calculate a statistical value of the intensity values of the detection wavelength groups in the N target objects for each of the M cluster matrices; and use the statistical values in the N target objects for each of the M cluster matrices to perform unmixing with respect to the N target objects, and generate K (K is an integer of 2 or more and M or less) pieces of dye data indicating a distribution for each of K fluorescent dyes.

Alternatively, a dye data acquisition program according to a sixth aspect of the embodiment is a dye data acquisition program for generating dye data indicating a distribution of fluorescent dyes in N (N is an integer of 2 or more) target objects based on spectrum data that is a distribution of fluorescence intensity values for each of C (C is an integer of 2 or more) detection wavelengths, for the N target objects, the dye data acquisition program causing a computer to execute: a step of clustering the C detection wavelengths into M (M is an integer of 2 or more and C−1 or less) detection wavelength groups based on the intensity values, for each of the N target objects, and generating M cluster matrices in which the intensity values for each of the N target objects are arranged for each clustered detection wavelength group; a step of calculating a statistical value of the intensity values of the detection wavelength groups in the N target objects for each of the M cluster matrices; and a step of using the statistical values in the N target objects for each of the M cluster matrices to perform unmixing with respect to the N target objects, and generating K (K is an integer of 2 or more and M or less) pieces of dye data indicating a distribution for each of K fluorescent dyes.

According to the fourth aspect, the fifth aspect, or the sixth aspect, spectrum data of a fluorescence distribution at C detection wavelengths is acquired for each of N target objects. This spectrum data is clustered into M detection wavelength groups, M cluster matrices in which the intensity values of the detection wavelength groups are arranged for each of the N target objects are generated, and the statistical value of the intensity values of the detection wavelength groups is calculated for each of the M cluster matrices. Furthermore, as a result of performing unmixing based on the statistical values of the M cluster matrices, K pieces of dye data indicating the distribution of the K fluorescent dyes for each of the target objects are generated. As a result, even when a type of dye to be observed, a type of excitation light used for observation, or the like changes, unmixing suitable for the observation conditions is executed, and dye data that is fluorescence spectrum data with high accuracy can be obtained.

### Advantageous Effects of Invention

According to one aspect of the embodiment, a fluorescence spectrum with high accuracy can be obtained when the observation conditions change.

### BRIEF DESCRIPTION OF DRAWINGS

FIG. 1 is a schematic configuration diagram of a dye data acquisition system 1 according to an embodiment.

FIG. 2 is a schematic configuration diagram of a data acquisition device 3 in FIG. 1.

FIG. 3 is a block diagram illustrating an example of a hardware configuration of a data processing device 5 in FIG. 1.

FIG. 4 is a block diagram illustrating a functional configuration of the data processing device 5 in FIG. 1.

FIG. 5 is a diagram illustrating matrix data Y′ regenerated by a statistical value calculation unit 203 in FIG. 4 and dye matrix data X′ derived by a matrix estimation unit 204 in FIG. 4.

FIG. 6 is a flowchart illustrating a procedure of a dye data acquisition method according to the embodiment.

FIG. 7 is a graph for describing a method of general population identification of an analyte in flow cytometry.

FIG. 8 is a graph illustrating a distribution of dye data on two dyes acquired by omitting clustering processing in the dye data acquisition system 1.

FIG. 9 is a graph illustrating a distribution of dye data on two dyes acquired by executing clustering processing in the dye data acquisition system 1.

FIG. 10 is a graph illustrating a distribution of dye data on two dyes acquired by omitting clustering processing in the dye data acquisition system 1.

FIG. 11 is a graph illustrating a distribution of dye data on two dyes acquired by executing clustering processing in the dye data acquisition system 1.

FIG. 12 is a graph illustrating a histogram of intensity in a certain fluorescence wavelength band and a histogram of an expression level of dye B acquired by the dye data acquisition system 1 according to the embodiment.

FIG. 13 is a schematic configuration diagram of a data acquisition device 3A according to a modification.

### DESCRIPTION OF EMBODIMENTS

Hereinafter, an embodiment of the present invention will be described in detail with reference to the accompanying drawings. Note that in the description, the same reference numerals are used for the same elements or elements having the same functions, and redundant description is omitted.

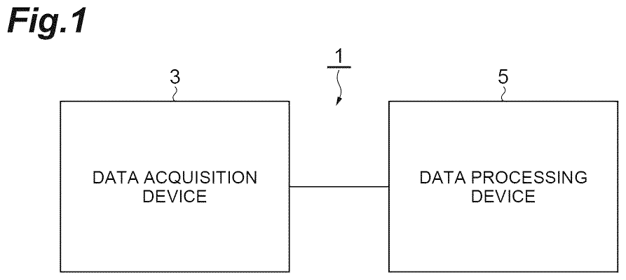

FIG. 1 is a schematic configuration diagram of a dye data acquisition system 1 which is a dye data acquisition device according to an embodiment. The dye data acquisition system 1 is a device for generating dye data for specifying the amount of dye (fluorescent dye) contained in a sample such as a cell (cell) or a particle which is an analyte. The dye data generated by the dye data acquisition system 1 is used for the purpose of counting, sorting, characteristic analysis, and the like of cells or the like through analysis of the data. Therefore, the dye data acquisition system 1 is required to generate dye data for a large number of analytes with high throughput. The dye data acquisition system 1 includes a data acquisition device 3 that performs analysis by flow cytometry on a sample, and a data processing device 5 that processes data acquired by the data acquisition device 3. The data acquisition device 3 and the data processing device 5 may be configured so as to be able to transmit and receive data by using wired communication or wireless communication between them, or may be configured so as to be able to input and output data via a recording medium. In addition, the data acquisition device 3 and the data processing device 5 may be integrated into a single device.

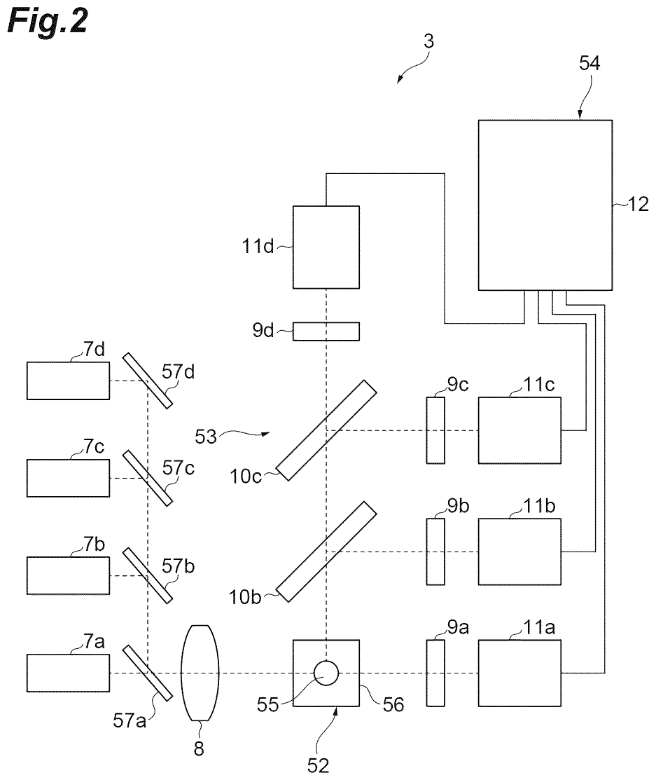

FIG. 2 is a schematic configuration diagram of the data acquisition device 3 of FIG. 1. The data acquisition device 3 is a system for performing flow cytometry, is generally called a flow cytometer, and includes a fluid system 52, an optical system (optical system) 53, and an electronic system (signal processing device) 54.

The fluid system 52 is configured to include a flow cell 56 into which a sample fluid including an analyte such as a cell or a particle is injected and which is capable of aligning and passing the analyte included in the sample fluid through a thin channel 55. The flow cell 56 is also provided with a function (not illustrated) of sorting (classifying and distributing) the gated analytes by electric field control or the like.

The optical system 53 is a system that optically analyzes the analyte passing through the flow cell 56 by flow cytometry. The optical system 53 includes light sources 7a, 7b, 7c, and 7d, dichroic mirrors 57a, 57b, and 57c, a mirror 57d, a lens 8, filters 9a, 9b, 9c, and 9d, dichroic mirrors 10b and 10c, and photodetectors 11a, 11b, 11c, and 11d, and guides various kinds of light emitted from the analyte during flow cytometry to the photodetectors 11a, 11b, 11c, and 11d. Each of the light sources 7a, 7b, 7c, and 7d is a light source device that generates light (excitation light) having a center wavelength (excitation wavelength) different from those of the others. The light sources 7a, 7b, 7c, and 7d are, for example, laser light sources, light-emitting diodes, superluminescent diodes, or the like. The dichroic mirror 57a transmits a light beam emitted from the light source 7a toward the lens 8, and reflects light beams emitted from the other light sources 7b, 7c, and 7d toward the lens 8. The dichroic mirror 57b reflects light emitted from the light source 7b toward the dichroic mirror 57a, and transmits light emitted from the light sources 7c and 7d toward the dichroic mirror 57a. The dichroic mirror 57c reflects light emitted from the light source 7c toward the dichroic mirror 57b, and transmits light emitted from the light source 7d toward the dichroic mirror 57b. The mirror 57d reflects light emitted from the light source 7d toward the dichroic mirror 57c. The lens 8 condenses the light beams emitted from the light sources 7a, 7b, 7c, and 7d onto the channel 55 in the flow cell 56. The filter 9a transmits forward scattered light (that is, forward scattered light generated from the sample fluid by light irradiation, which is at least one light beam from the light sources 7a, 7b, 7c, and 7d). The dichroic mirror 10b reflects fluorescence (first fluorescence) in a first wavelength band (first detection wavelength) among the fluorescence generated from the sample fluid by irradiation with light beams respectively emitted from the light sources 7a, 7b, 7c, and 7d, and transmits the remaining fluorescence among the fluorescence generated from the sample fluid. The dichroic mirror 10c reflects fluorescence (second fluorescence) in a second wavelength band (second detection wavelength) out of the fluorescence transmitted through the dichroic mirror 10b, and transmits fluorescence (third fluorescence) in the remaining wavelength band (third detection wavelength) out of the fluorescence transmitted through the dichroic mirror 10b. The filter 9b transmits the first fluorescence in the first wavelength band reflected by the dichroic mirror 10b, and the filter 9c transmits the second fluorescence in the second wavelength band reflected by the dichroic mirror 10c. The filter 9d transmits the third fluorescence in the third wavelength band among the fluorescence transmitted through the dichroic mirror 10c. The photodetectors 11a, 11b, 11c, and lid are provided on the optical axes corresponding to the forward scattered light, the first fluorescence, the second fluorescence, and the third fluorescence, respectively, and measure the intensity of each of the forward scattered light, the first fluorescence, the second fluorescence, and the third fluorescence. The photodetectors 11a, 11b, 11c, and 11d are, for example, photomultiplier tubes, avalanche photodiodes, hybrid photodetectors (HPDs), silicon photomultipliers (SiPMs), or the like. In addition, the photodetectors 11a, 11b, 11c, and 11d may be implemented as a single photodetector having a plurality of detection ports. Examples of such a single photodetector include multi-anode photomultiplier tubes. The optical system 53 can measure the intensity of each fluorescence for each of C detection wavelengths (C is an integer of 2 or more) in accordance with the number of combinations of the dichroic mirror, the filter, and the photodetector.

Note that the optical system 53 can measure the intensity of each of the forward scattered light, the first fluorescence, the second fluorescence, and the third fluorescence while irradiating light beams of a plurality of wavelength bands from the light sources 7a, 7b, 7c, and 7d in a switched manner. As a result, the intensity of fluorescence in a plurality of wavelength bands can be efficiently measured. Furthermore, the optical system 53 may be capable of measuring the intensity of each of the forward scattered light, the first fluorescence, the second fluorescence, and the third fluorescence while continuously irradiating the sample with light beams of a plurality of wavelength bands from the light sources 7a, 7b, 7c, and 7d. Furthermore, the optical system 53 may have a configuration capable of observing side scattered light by a configuration similar to the above.

The electronic system 54 is a device for collecting data of the intensity of light measured by the optical system 53. Specifically, the electronic system 54 is electrically coupled to the plurality of photodetectors 11a, 11b, 11c, and 11d, performs A/D conversion on the intensity signal indicating the intensity detected in each channel of the plurality of photodetectors 11a, 11b, 11c, and 11d, generates array data in which the intensity values for each analyte after the A/D conversion are one-dimensionally arranged, and transmits the array data to the outside. Here, the electronic system 54 may generate the array data by performing A/D conversion on the intensity signals detected by the plurality of photodetectors 11a, 11b, 11c, and 11d as they are, or may generate the array data by correcting the intensity signal or the intensity value after the A/D conversion by various parameters and generating the array data based on the corrected intensity signal or the corrected intensity value.

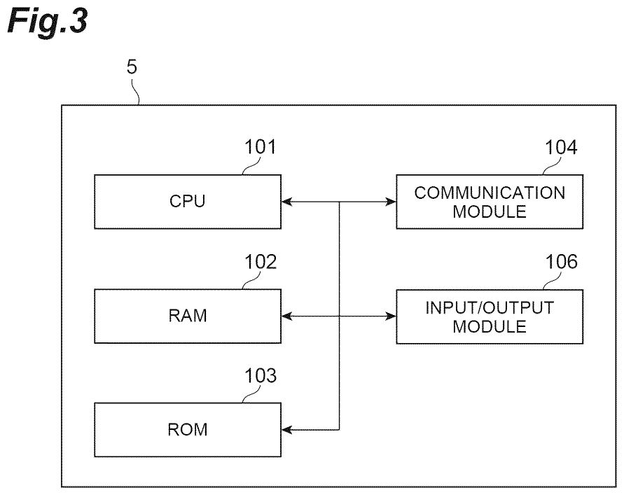

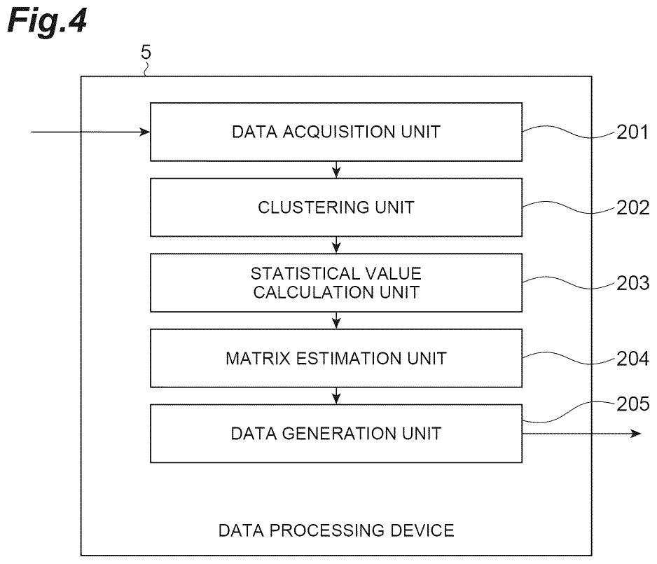

Next, the configuration of the data processing device 5 will be described with reference to FIGS. 3 and 4. FIG. 3 is a block diagram illustrating an example of a hardware configuration of the data processing device 5, and FIG. 4 is a block diagram illustrating a functional configuration of the data processing device 5.

As illustrated in FIG. 3, the data processing device 5 is physically a computer or the like including a central processing unit (CPU) 101 that is a processor, a random access memory (RAM) 102 and/or a read only memory (ROM) 103 that is a recording medium, a communication module 104, an input/output module 106, and the like, which are electrically coupled to each other. Note that the data processing device 5 may include, as input/output devices, a display, a keyboard, a mouse, a touch panel display, or the like, and may further include a data recording device such as a hard disk drive or a semiconductor memory.

Furthermore, the data processing device 5 may be constituted by a plurality of computers.

As illustrated in FIG. 4, the data processing device 5 includes, as functional components, a data acquisition unit 201, a clustering unit 202, a statistical value calculation unit 203, a matrix estimation unit 204, and a data generation unit 205. Each functional unit of the data processing device 5 illustrated in FIG. 4 is realized by loading a program (dye data acquisition program according to the embodiment) onto hardware such as the CPU 101 and the RAM 102, and, under the control of the CPU 101, operating the communication module 104, the input/output module 106, and the like, and reading and writing data in the RAM 102. The CPU 101 of the data processing device 5 executes the computer program to cause each functional unit shown in FIG. 4 to function, and sequentially executes processing corresponding to the dye data acquisition method to be described later. Note that the CPU 101 may be a single piece of hardware or may be implemented as a software processor in programmable logic such as an FPGA. The RAM or the ROM may be implemented as a stand-alone hardware device or may be embedded in programmable logic such as an FPGA. Various types of data necessary for execution of the computer program, as well as various types of data generated by execution of the computer program, are all stored in an internal memory such as the ROM 103 or the RAM 102, or a storage medium such as a hard disk drive. Hereinafter, the functions of the functional components of the data processing device 5 will be described in detail.

The data acquisition unit 201 acquires array data related to fluorescence of C (C is an integer of 2 or more) wavelength bands designated in advance for N (N is an integer of 2 or more) analytes from the data acquisition device 3. These C pieces of array data are spectrum data obtained by measuring a distribution of the fluorescence intensity values for each of the C wavelength bands from the N analytes while light beams of a plurality of wavelength bands are switched and emitted in the data acquisition device 3. At this time, the number C of the pieces of array data to be acquired (the number C of the wavelength bands of fluorescence to be observed) is specified in advance so as to be equal to or more than a maximum number of dyes that can be included in the analyte.

The clustering unit 202 reads the C pieces of array data acquired by the data acquisition unit 201, and executes clustering on the N analytes constituting the C pieces of array data based on the intensity value of each analyte for each of the C wavelength bands. Prior to the clustering processing, the clustering unit 202 generates matrix data Y in which the intensity values of the N analytes constituting each of the C pieces of array data are one-dimensionally arranged in parallel.

Then, the clustering unit 202 clusters the N analytes into L (L is an integer of 2 or more and N−1 or less) target object groups based on the distribution information of the intensity values of the wavelength bands of each fluorescence. For example, the clustering unit 202 selects a wavelength band in which a difference in intensity value is likely to occur between dyes, creates a histogram of intensity values of the wavelength band, and sets a threshold between two peaks based on the histogram. Furthermore, the clustering unit 202 can cluster the analyte into two target object groups by comparing the set threshold with the intensity value of the array data. The clustering unit 202 can classify the analyte into three or more target object groups by a similar function. Here, the number L of the target object groups to be clustered by the clustering unit 202 is set in advance as a parameter stored in the data processing device 5 in correspondence with the number of types of dyes that can exist in the analyte. Then, the clustering unit 202 regenerates the matrix data Y in which the intensity values of the analytes of the C pieces of array data are one-dimensionally arranged in parallel by dividing the matrix data Y into a cluster matrix for each of the L target object groups. Note that the number L of the target object groups to be clustered by the clustering unit 202 may be set in advance according to the type of detection wavelength band and the number (C) of the detection wavelength bands. Furthermore, the number L of the target object groups to be clustered by the clustering unit 202 may be set independently of these.

The statistical value calculation unit 203 and the matrix estimation unit 204 obtain a mixing matrix A for generating K pieces of dye data indicating a distribution of each of K (K is an integer of 2 or more and C or less) dyes from the C pieces of array data based on the L cluster matrices obtained for the analyte. In general, according to the calculation method of nonnegative matrix factorization (NNW), the relationship between the matrix data Y which is an observation value matrix and the dye matrix data X in which K pieces of dye data are arranged one-dimensionally in parallel for each analyte is expressed by the following formula by using the mixing matrix A; Y=AX. Here, Y is matrix data of C rows and N columns, A is matrix data of C rows and K columns, and X is matrix data of K rows and N columns. On the contrary, when the value of the mixing matrix A is obtained, the dye matrix data X can be derived by the following formula by using an inverse matrix A-1 of the mixing matrix A and the matrix data Y (this processing is called unmixing);

$$X = {A}^{- 1} Y .$$

Here, the statistical value calculation unit 203 regenerates matrix data Y by compressing the matrix data Y generated by the clustering unit 202 in units of target object groups clustered by the clustering unit 202. Specifically, the statistical value calculation unit 203 calculates a statistical value for each target object group of the clustered cluster matrix for the intensity value of each row of the matrix data Y, and compresses the target object group of each row into one target object group having the calculated statistical value. As a result, the statistical value calculation unit 203 regenerates the matrix data Y which is matrix data of C rows and L columns. The statistical value calculation unit 203 may calculate, as the statistical value, an average value based on the integrated value of the intensity values, may calculate a mode of the intensity values, or may calculate an intermediate value of the intensity values.

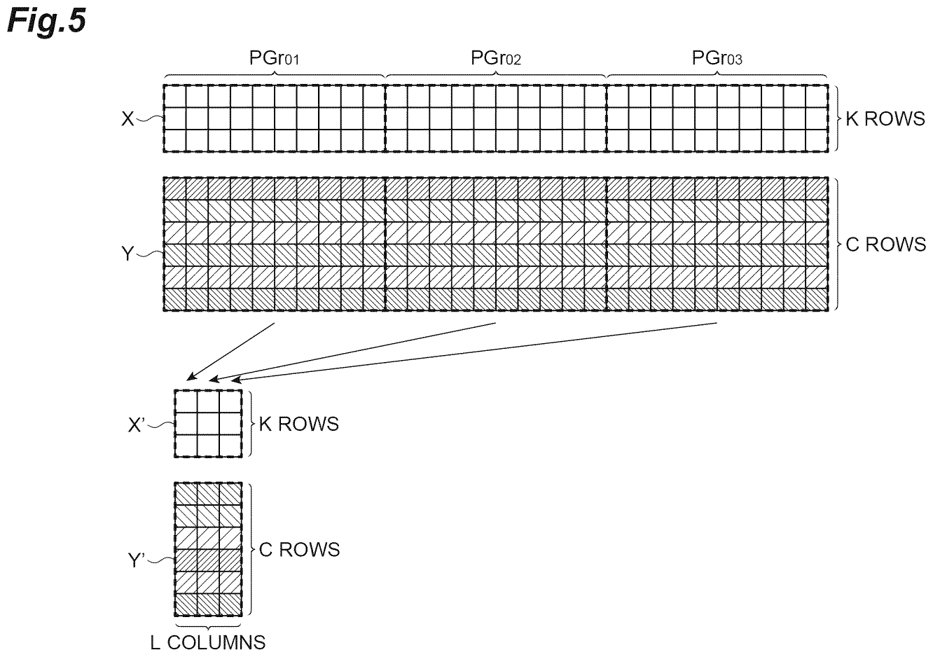

The matrix estimation unit 204 derives the mixing matrix A based on the matrix data Y′ by utilizing the property that the following formula including the mixing matrix A holds true in the matrix data Y′ regenerated by the statistical value calculation unit 203 and the dye matrix data X′ compressed in the same manner from the dye matrix data X; Y′=AX′. FIG. 5 illustrates an image of the matrix data Y′ regenerated by the statistical value calculation unit 203 and the dye matrix data X′ corresponding thereto. One grid illustrated in FIG. 5 represents one element of the matrix data. For example, the dye matrix data X and the matrix data Y divided into three target object groups PGr₀₁ to PGr₀₃ are compressed into the dye matrix data X′ and the matrix data Y′ of three columns with the statistical values for each of the target object groups PGr₀₁ to PGr₀₃ as representative values.

The matrix estimation unit 204 derives the mixing matrix A based on the matrix data Y′ as follows. That is, the matrix estimation unit 204 sets an initial value for the mixing matrix A, calculates the following loss function (loss value) Los while sequentially changing the value of the mixing matrix A, and derives the mixing matrix A that reduces the value of the loss function Los. Note that a regularization term such as L1 norm λ|A|(λ is a coefficient indicating a degree to which the regularization term is emphasized) may be added to the loss function.

$$Los = {\sum }_{j}^{C} \frac{1}{a} {( {Y}^{′} - {AX}^{′} )}_{1 j}^{2} + {\sum }_{j}^{C} \frac{1}{b} {( {Y}^{′} - {AX}^{′} )}_{2 j}^{2} + {\sum }_{j}^{C} \frac{1}{c} {( {Y}^{′} - {AX}^{′} )}_{3 j}^{2} \qquad [ Mathematical Formula 1 ]$$

In the above formula, j is a parameter indicating a position (corresponding to the wavelength band of fluorescence) of a row of the matrix data, a subscript 1j of the matrix indicates matrix data of a j-th row of the first cluster matrix, a subscript 2j of the matrix indicates matrix data of a j-th row of the second cluster matrix, and a subscript 3j of the matrix indicates matrix data of a j-th row of the third cluster matrix. In addition, the parameters a, b, and c indicate the average values of the statistical values of the respective columns of the matrix data Y′.

As described above, the matrix estimation unit 204 calculates the loss function with reference to the statistical values of the C pieces of matrix data Y′ for each of the L cluster matrices divided by the clustering unit 202, calculates the loss function Los based on a sum of the L loss functions, and obtains the mixing matrix A based on the loss function Los. At this time, the matrix estimation unit 204 corrects the loss function calculated for each of the L cluster matrices by dividing the loss function by the average values a, b, and c of the statistical values of the C pieces of matrix data Y′, and then calculates a sum of the corrected loss functions to obtain the loss function Los. Note that the matrix estimation unit 204 may calculate the loss function for each of the L cluster matrices by correcting the loss function by dividing the row component for each of the wavelength bands of fluorescence having a difference value Y′-AX′ by using the C statistical values corresponding to each wavelength band of the fluorescence.

Note that the above formula can also be generalized as follows. That is, the matrix estimation unit 204 derives the mixing matrix A and the dye matrix data X′ based on the matrix data Y′ as follows. That is, the matrix estimation unit 204 sets initial values for the mixing matrix A and the dye matrix data X′, calculates the loss function (loss value) Los by using the following formula while sequentially changing the values of the mixing matrix A and the dye matrix data X′, and derives the mixing matrix A and the dye matrix data X′ that reduce the value of the loss function Los. Note that a regularization term such as L1 norm λ|A|(λ is a coefficient indicating a degree to which the regularization term is emphasized) may be added to the loss function. Alternatively, the calculation may be performed with a constraint that the mixing matrix A and the dye matrix data X′ have nonnegative values.

$$Los = {\sum }_{i}^{L} {Los}_{i} = {\sum }_{i}^{L} {\sum }_{j}^{C} {{w}_{ij} ( {Y}^{′} - {AX}^{′} )}_{ij}^{2} \qquad [ Mathematical Formula 2 ]$$

In the above formula, j is a parameter indicating a position (corresponding to the wavelength band of fluorescence) of the row of the matrix data, and i is a parameter indicating a position (corresponding to an i-th cluster) of the column of the matrix data. Further, wᵢⱼ represents a weight of each element of the matrix data, and may be calculated from the value of each element or its standard deviation. In addition, it is also possible to set all wᵢⱼ to the same value and not consider the weight of each element. Note that a formula in which the average values of the statistical values of the respective columns of the matrix data Y′ are set as a, b, c, . . . in the above formula and is replaced with w₁ⱼ=1/a, w₂ⱼ=1/b, and w₃ⱼ=1/c is the same as the formula of the loss function Los described above.

As described above, the matrix estimation unit 204 calculates the loss function with reference to the statistical values of the C pieces of matrix data Y′ for each of the L cluster matrices divided by the clustering unit 202, calculates the loss function Los based on the sum of L loss functions Losᵢ, and obtains the mixing matrix A based on the loss function Los. Note that the matrix estimation unit 204 may calculate the loss function Losᵢ for each of the L cluster matrices by correcting the loss function Losᵢ by dividing the row component for each wavelength band of the fluorescence having a difference value Y′-AX′ by using the C statistical values corresponding to each wavelength band of the excitation light.

The data generation unit 205 acquires K pieces of dye data by unmixing the C pieces of array data obtained for the analyte using the mixing matrix A derived by the matrix estimation unit 204. Specifically, the data generation unit 205 calculates the dye matrix data X by applying the inverse matrix A⁻¹ of the mixing matrix A to the matrix data Y generated by the clustering unit 202 based on the C pieces of array data. Then, the data generation unit 205 regenerates K pieces of dye data from the dye matrix data X, and outputs the regenerated K pieces of dye data. The output destination at this time may be an output device of the data processing device 5 such as a display or a touch panel display, or may be an external device coupled to the data processing device 5 so as to be capable of data communication. In addition, the dye data generated by the data generation unit 205 may be used for data analysis for the purpose of counting, sorting, characteristic analysis, and the like of the analyte.

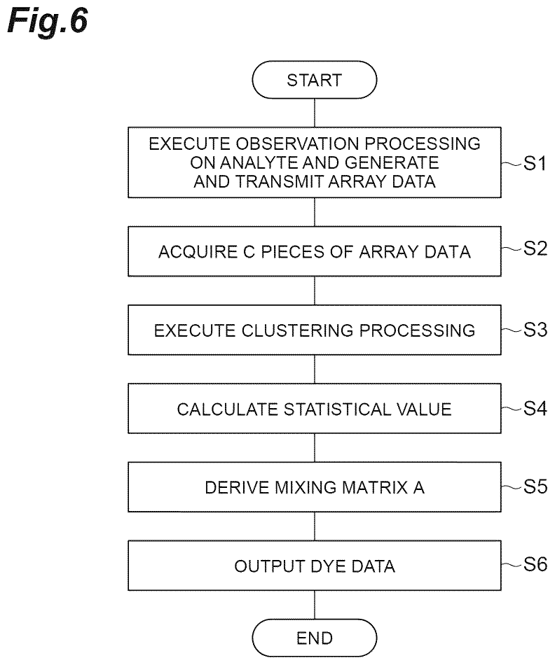

Next, a procedure of observation processing on the analyte using the dye data acquisition system 1 according to the present embodiment, that is, a flow of a dye data acquisition method according to the present embodiment will be described. FIG. 6 is a flowchart illustrating a procedure of observation processing by the dye data acquisition system 1.

First, the data acquisition device 3 executes observation processing on a plurality of analytes, and as a result, array data is generated and transmitted (step S1). Next, the data acquisition unit 201 of the data processing device 5 acquires the array data of C fluorescence wavelength bands from the data acquisition device 3 (step S2; data acquisition step).

Further, clustering is executed on C pieces of array data by the clustering unit 202 of the data processing device 5, and N analytes of the array data are clustered into L target object groups (step S3; clustering step). Next, the statistical value calculation unit 203 of the data processing device 5 calculates statistical values of the L target object groups, thereby regenerating matrix data Y′ based on matrix data Y generated by the clustering unit 202 (step S4; calculation step).

Then, the matrix estimation unit 204 of the data processing device 5 derives a mixing matrix A based on the matrix data Y′ (step S5; data generation step). Finally, the data generation unit 205 of the data processing device 5 unmixes the matrix data Y generated based on the C pieces of array data for the analyte using the mixing matrix A, thereby acquiring and outputting K pieces of dye data (step S6; data generation step). Thus, the observation processing for the plurality of analytes is completed.

According to the dye data acquisition system 1 described above, spectrum data indicating the distribution of fluorescence in the C wavelength bands is acquired for each of the N analytes. This spectrum data is clustered into L target object groups, L cluster matrices in which the intensity values of the target object groups are arranged are generated for each of the C fluorescence wavelength bands, and the statistical values of the intensity values of the target object groups are calculated for each of the L cluster matrices. Furthermore, as a result of performing unmixing based on the statistical values of the L cluster matrices, K pieces of dye data indicating the distribution of the K fluorescent dyes for each of the target objects are generated. As a result, in a case where a type of dye to be observed, a type of excitation light used for observation, or the like changes, even in a case where a deviation in the number of each dye occurs, unmixing suitable for the observation conditions is executed, and dye data that is fluorescence spectrum data with high accuracy can be obtained.

Flow cytometry is a technique that enables identification or quantification of a cell population by staining cells, cell surface proteins, and intracellular proteins, and can be used for applications such as cell sorting and immunophenotyping. According to the present embodiment, it is possible to accurately identify which cell is tumorigenic, for example, by analyzing a combination of expression of antibodies used for blood cells based on the acquired dye data.

In the present embodiment, the spectrum data, which is the distribution of the intensity values for each of the C fluorescence wavelength bands, is acquired by irradiating the analyte with each of the light beams of the plurality of wavelength bands. Thus, by using light beams of a plurality of wavelength bands, fluorescence from a plurality of types of fluorescent dyes can be efficiently observed. As a result, it is possible to obtain dye data with high accuracy when a plurality of fluorescent dyes are to be observed.

In addition, in the present embodiment, N analytes are clustered based on the distribution information of the intensity values for each of the C fluorescence wavelength bands. By using the distribution information in this manner, clustering can be performed based on the similarity of the fluorescence wavelength distribution. As a result, unmixing suitable for observation conditions is executed, and dye data with high accuracy can be obtained.

In the present embodiment, the statistical value of the array data is calculated based on the integrated value, the mode, or the intermediate value of the intensity values of the target object group. In this case, unmixing can be executed based on the overall tendency of the intensity values of the L target object groups in the cluster matrix, and unmixing suitable for the observation conditions is executed, and dye data with high accuracy can be obtained.

Furthermore, in the present embodiment, the mixing matrix A is obtained using the statistical values of the C fluorescence wavelength bands for each of the L cluster matrices, and unmixing is performed using the mixing matrix A. In this case, even when the number of target objects to be analyzed, the type of excitation light used for observation, or the number of fluorescence bands to be observed increases, an amount of calculation when unmixing is performed can be suppressed. In addition, by performing unmixing by using the statistical values of the intensity values for each clustered cluster matrix, an accuracy of separation of the dye data can also be improved. Conventionally, derivation of the mixing matrix A has been performed by calculating the mixing matrix Abased on reference information (fluorescence spectrum, absorption spectrum, or the like) of each dye. In the present embodiment, even when such reference information is unknown, the mixing matrix can be estimated from the matrix data Y obtained from the array data.

As a result, it is possible to improve throughput when dye data is acquired while improving accuracy of separation data.

Furthermore, in the present embodiment, the loss function Los is calculated based on the statistical values of the C fluorescence wavelength bands for each of the L cluster matrices using the nonnegative matrix factorization, and the mixing matrix A is obtained based on the sum of the loss functions Los. In this case, the loss function Los is calculated based on the statistical values of the L target object groups of the clustered array data, the mixing matrix A is obtained based on the sum of these loss functions Los, and the unmixing can be executed by using the mixing matrix A. As a result, even when there is a difference in amount of each dye included in the plurality of analytes, the accuracy of the generated dye data can be further improved. That is, in a case where the loss function Los is calculated for the array data without clustering, the separation accuracy of the dye having a relatively large amount is emphasized, and as a result, the separation accuracy of the dye having a relatively small amount decreases. In the present embodiment, the separation accuracy of a plurality of dyes can be uniformly improved. In addition, it is also possible to improve throughput at the time of acquiring dye data.

Furthermore, in the present embodiment, the loss function Los is corrected for each of the L cluster matrices using the coefficients a, b, and c based on the statistical values, and the mixing matrix A is obtained based on the sum of the corrected loss functions Los. In this way, the loss function Los is calculated based on the statistical values of the L target object groups of the clustered array data, and each loss function Los is corrected based on the statistical values when the sum of the loss functions Los is obtained. As a result, even when there is a difference in fluorescence intensity of each dye in the array data of the analyte, dye data can be generated with high accuracy. That is, when the loss function Los is calculated without correcting the L loss functions Los, the separation accuracy of the relatively strong dye is emphasized, and as a result, the separation accuracy of the relatively weak dye is reduced. In the present embodiment, the separation accuracy of a plurality of dyes can be uniformly improved.

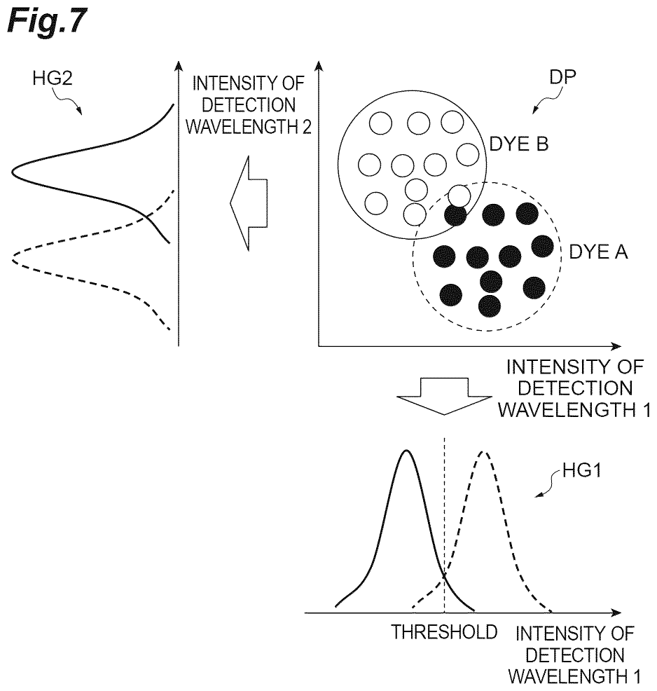

FIG. 7 is a graph for describing a method of general population identification of an analyte in flow cytometry. In general flow cytometry, a graph of a dot plot DP is generated based on the fluorescence intensity in the wavelength band of “detection wavelength 1” and the fluorescence intensity in the wavelength band of “detection wavelength 2” for a plurality of cells, and a histogram HG1 of the intensity of “detection wavelength 1” and a histogram HG2 of the intensity of “detection wavelength 2” are created based on the dot plot DP. Then, by performing gating based on the threshold determined based on the distributions of HG1 and HG2 or based on the dot plot DP, a population of “dye A” and a population of “dye B” are identified.

However, fluorescence from a single dye includes a plurality of types of fluorescence wavelength bands, and the distribution of the wavelength bands included in fluorescence is complicatedly changed between different dyes. In addition, one analyte may include a plurality of dyes. In the conventional population identification method described above, when the distributions of the histograms HG1 and HG2 overlap each other between the dyes, it is difficult to accurately separate the two dyes by the threshold, and it is not possible to accurately identify the dyes. In addition, even when the gating is performed on the dot plot DP, it is difficult to separate two dyes with high accuracy, and the dyes cannot be identified with high accuracy. Moreover, it is difficult to identify a plurality of dyes included in one analyte. On the other hand, according to the present embodiment, it is possible to quantitatively obtain an expression level of each dye with high accuracy by unmixing and processing the array data of the C fluorescence wavelength bands.

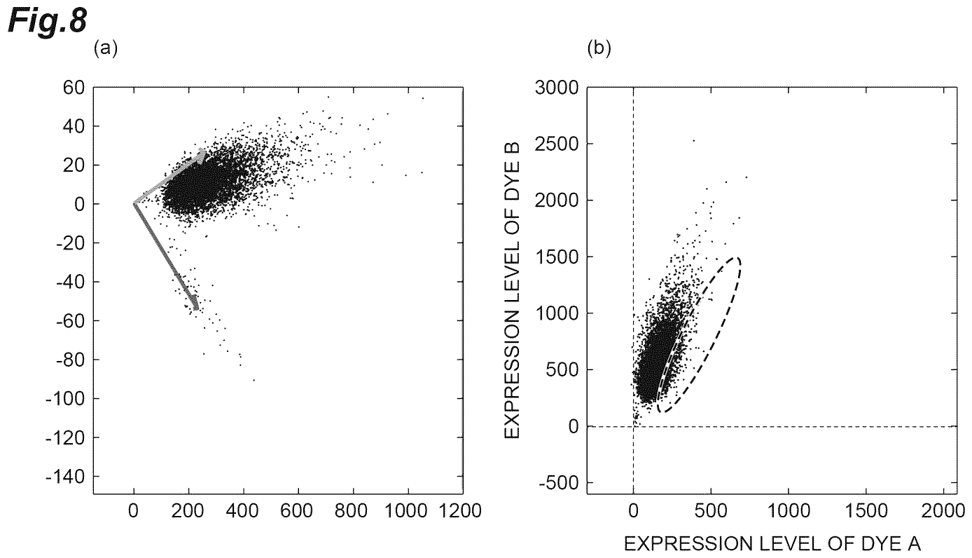

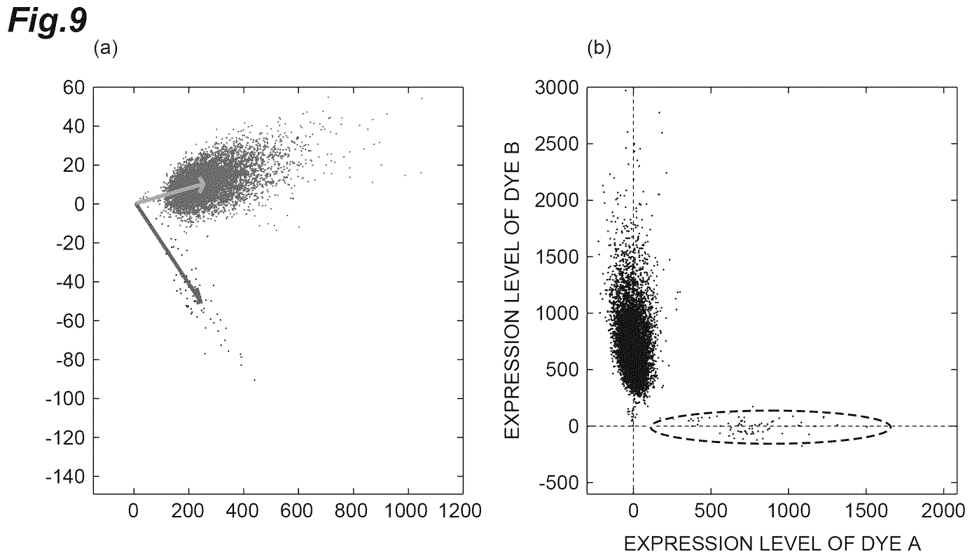

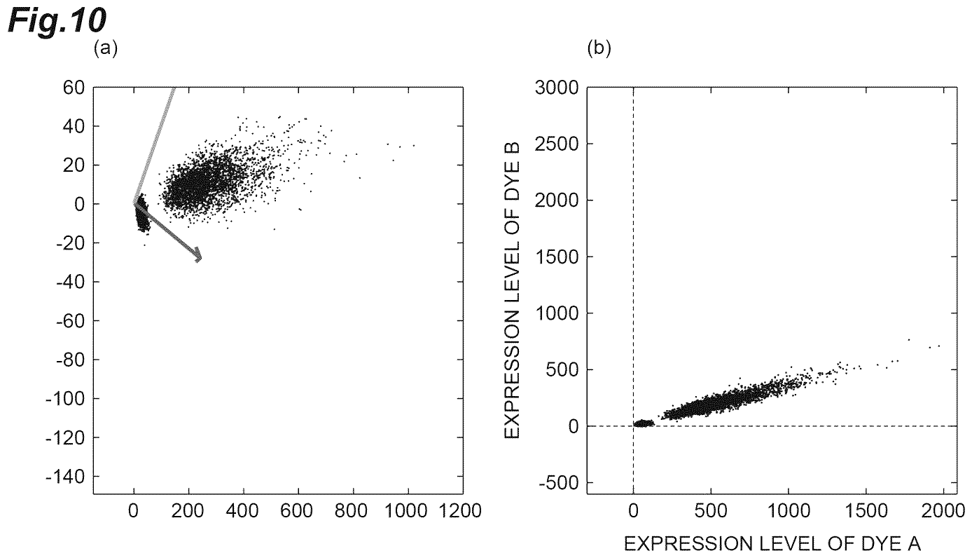

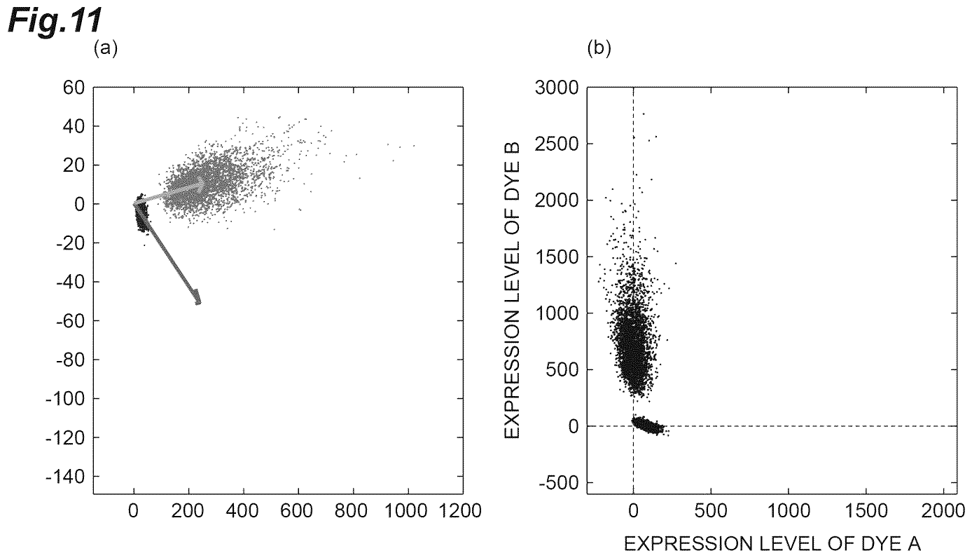

FIGS. 8 to 11 illustrate a distribution of dye data on two dyes acquired in the dye data acquisition system 1. In FIGS. 8 to 11, part (a) is a graph illustrating dot plots of intensity values in two fluorescence wavelength bands, and part (b) is a graph illustrating expression levels (distributions) of two dyes “dye A” and “dye B”. FIG. 8 illustrates a result of acquiring the dye data by omitting the clustering processing in the data processing device 5 when there is a difference in the number of dyes (when the number of cells of the dye A is 1/100 of the number of cells of the dye B), and FIG. 9 illustrates a result of acquiring the dye data by executing the clustering processing in the data processing device 5 when there is a difference in the number of dyes (when the number of cells of the dye A is 1/100 of the number of cells of the dye B). In addition, FIG. 10 illustrates a result of acquiring dye data by omitting the clustering processing in the data processing device 5 when there is a difference in intensity for each dye (when the intensity of the cell of the dye A is 1/10 of the intensity of the cell of the dye B), and FIG. 11 illustrates a result of acquiring dye data by executing the clustering processing in the data processing device 5 when there is a difference in intensity for each dye (when the intensity of the cell of the dye A is 1/10 of the intensity of the cell of the dye B).

As illustrated in FIG. 8, when the clustering processing is omitted, monochromatic cells of the dye A exist in the range indicated by the dotted line, but the expression levels of the two dyes are not separately obtained. On the other hand, as illustrated in FIG. 9, when the clustering processing is executed, the expression levels of the monochromatic cells of the dye A are calculated in the range indicated by the dotted line, and the expression levels of the two dyes are accurately separated.

As illustrated in FIG. 10, when the clustering processing is omitted, the expression levels of the two dyes are not separately obtained. On the other hand, as illustrated in FIG. 11, when the clustering processing is executed, the expression levels of the two dyes are separated, and the expression levels of the two dyes are accurately calculated.

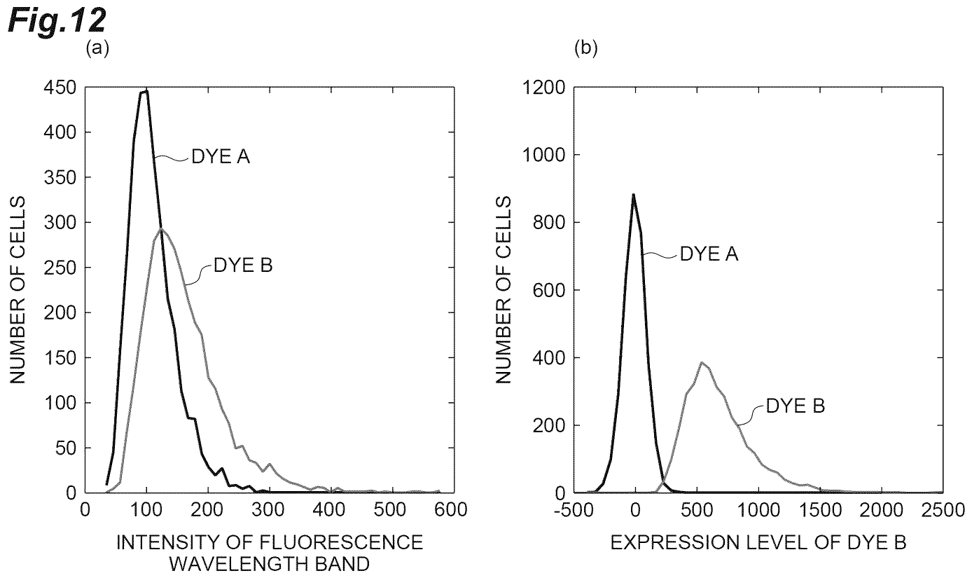

In FIG. 12, part (a) illustrates a histogram for each of the cell of dye A and the cell of dye B having the intensity in a certain fluorescence wavelength band acquired by the dye data acquisition system 1, and part (b) illustrates a histogram of the expression level of dye B acquired by the dye data acquisition system 1. As described above, since the histogram of the intensity of the fluorescence wavelength band has a large overlap between the two dyes, it is understood that it is difficult to identify the dye depending on the histogram. On the other hand, according to the dye data obtained according to the present embodiment, the expression level of the dye B can be accurately separated.

Although various embodiments of the present invention have been described above, the present invention is not limited to the above embodiments, and may be modified or applied to other objects without changing the gist described in each claim.

As a technique of clustering the target object groups in the data processing device 5, a technique using machine learning such as a K-means method, a technique using deep learning, or the like may be adopted.

In addition to the K-means method, a technique using machine learning such as a decision tree, a support vector machine, a K nearest neighbor (KNN), a self-organizing map, spectral clustering, a Gaussian mixture model, DBSCAN, Affinity Propagation, MeanShift, Ward, Agglomerative Clustering, OPTICS, and BIRCH, a technique using deep learning, or the like may be adopted as the technique of clustering target object groups in the data processing device 5. In addition, pre-processing may be performed on the matrix data Y before clustering is applied. For example, the dimension of C-dimensional data of each analyte may be reduced by Phasor Analysis, principal component analysis, singular value decomposition, independent component analysis, linear discriminant analysis, t-SNE, UMAP, other machine learning, or the like.

The clustering unit 202 of the data processing device 5 may cluster, for the matrix data Y, C fluorescence wavelength bands into M (M is an integer of 2 or more and C−1 or less) wavelength groups (detection wavelength groups) based on the intensity values of the respective wavelength bands, and may further generate M cluster matrices in which the intensity values of the respective detection target objects are arranged for each wavelength group. The generation of the M cluster matrices may be performed before or after the generation of the L cluster matrices described above. At this time, the statistical value calculation unit 203 regenerates the matrix data Y′ by compressing the matrix data Y using the statistical value even in units of clustered wavelength groups by a method similar to the method described above. In this way, by clustering the fluorescence wavelength bands, the S/N of the dye data can be improved. In addition, the amount of calculation at the time of performing unmixing can be further suppressed. In addition, by performing unmixing using the statistical values of the intensity values for each clustered wavelength group, the accuracy of separation of the dye data can also be maintained.

Note that the clustering unit 202 of the data processing device 5 may perform only the clustering to the M wavelength groups and only generate the M cluster matrices without performing the clustering to the L target object groups in the above-described embodiment. In this case, the data generation unit 205 of the data processing device 5 performs unmixing using the statistical values in N analytes for each of the M cluster matrices to generate K (K is an integer of 2 or more and M or less) pieces of dye data.

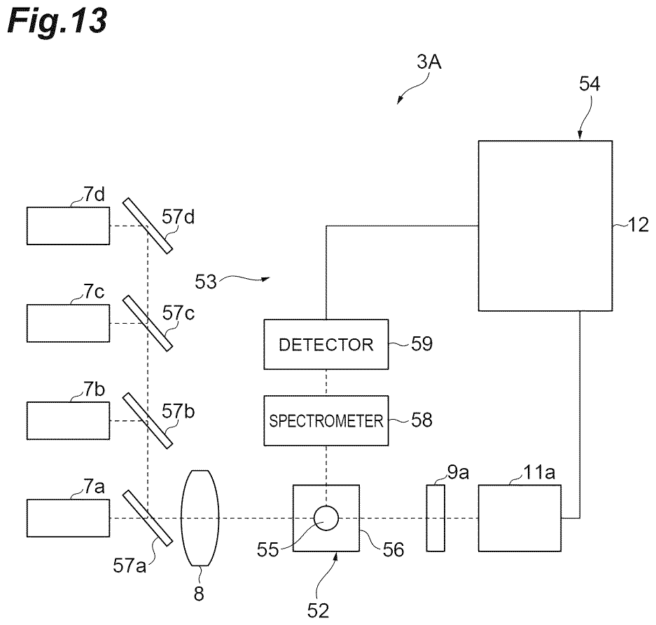

The data acquisition device 3 of the above embodiment may be changed to the configuration illustrated in FIG. 13. The difference between the data acquisition device 3A according to the modification illustrated in FIG. 13 and the data acquisition device 3A is that the former includes a spectrometer 58 and a detector 59 as the optical system 53.

The spectrometer 58 disperses the fluorescence generated from the sample fluid into a plurality of wavelength bands (for example, wavelength bands of 1024 channels). The detector 59 is a one-dimensional detector or a two-dimensional detector having a plurality of pixels (for example, 1024 pixels), measures the intensity of fluorescence in each wavelength band incident on each pixel from the spectrometer 58, and outputs the intensity to the electronic system 54. According to such a data acquisition device 3A, it is possible to generate array data of a plurality of fluorescence wavelength bands. For example, the array data of 1024 channels generated by the data acquisition device 3A is divided into 512 cluster matrices by clustering two adjacent channels into one wavelength group by the data processing device 5.

In the first aspect, in the data acquisition step, it is preferable to acquire spectrum data that is a distribution of intensity values for each of the C detection wavelengths by irradiating the target object with each of excitation light beams of a plurality of excitation wavelengths. Furthermore, in the second aspect, it is preferable to further include a data acquisition device that acquires spectrum data that is a distribution of intensity values for each of the C detection wavelengths by irradiating the target object with each of the excitation light beams of the plurality of excitation wavelengths. Thus, by using the excitation light beams of a plurality of excitation wavelengths, fluorescence from a plurality of types of fluorescent dyes can be efficiently observed. As a result, it is possible to obtain dye data with high accuracy when a plurality of fluorescent dyes are to be observed.

Furthermore, in the first aspect, in the clustering step, it is also preferable to cluster the N target objects based on the distribution information of the intensity values for each of the C detection wavelengths. By using the distribution information in this manner, clustering can be performed based on the similarity of the wavelength distribution. As a result, unmixing suitable for observation conditions is executed, and dye data with high accuracy can be obtained.

Furthermore, in the first aspect, in the calculation step, it is also preferable that the statistical value is calculated based on the integrated value, the mode, or the intermediate value of the intensity values of the target object groups. In this case, unmixing suitable for observation conditions is executed, and dye data with high accuracy can be obtained.

Furthermore, in the first aspect, in the data generation step, it is preferable that the mixing matrix is obtained by using the statistical values of the C detection wavelengths for each of the L cluster matrices, and unmixing is performed by using the mixing matrix. In this case, even when the number of target objects, the type of excitation light used for observation, or the number of fluorescence bands to be observed increases, an amount of calculation when unmixing is performed can be suppressed. In addition, by performing unmixing by using the statistical values of the intensity values for each clustered cluster matrix, an accuracy of separation of the dye data can also be improved. As a result, it is possible to improve throughput when dye data is acquired while improving accuracy of separation data.

Furthermore, in the first aspect, in the data generation step, it is also preferable the loss value is calculated based on the statistical values of the C detection wavelengths for each of the L cluster matrices by using nonnegative matrix factorization, and the mixing matrix is obtained based on the sum of the loss values. In this case, it is possible to improve throughput when dye data is acquired while improving accuracy of separation data.

Furthermore, in the first aspect, in the data generation step, it is also preferable that the loss value is corrected based on the statistical value for each of the L cluster matrices, and the mixing matrix is obtained based on the sum of the corrected loss values. In this way, even when there is a deviation in the intensity of each fluorescent dye, the accuracy of separation of dye data can be improved.

Furthermore, in the first aspect, in the clustering step, it is also preferable to cluster the C detection wavelengths into M (M is an integer of 2 or more and C−1 or less) detection wavelength groups based on the intensity values for each of the N target objects, and further generate M cluster matrices in which the intensity values for each of the N target objects are arranged for each clustered detection wavelength group. In this way, the amount of calculation at the time of performing unmixing can be further suppressed. In addition, by performing unmixing using the statistical values of the intensity values for each clustered detection wavelength group, the accuracy of separation of the dye data can also be maintained.

The dye data acquisition method of the embodiment is [1] “a dye data acquisition method including: a data acquisition step of acquiring spectrum data that is a distribution of fluorescence intensity values for each of C (C is an integer of 2 or more) detection wavelengths, for N (N is an integer of 2 or more) target objects; a clustering step of clustering the N target objects into L (L is an integer of 2 or more and N−1 or less) target object groups based on the intensity values of each target object for each of the C detection wavelengths, and generating L cluster matrices in which the intensity values for each of the C detection wavelengths are arranged for each clustered target object group; a calculation step of calculating a statistical value of the intensity values of the target object groups in the C detection wavelengths for each of the L cluster matrices; and a data generation step of using the statistical values in the C detection wavelengths for each of the L cluster matrices to perform unmixing with respect to the C detection wavelengths, and generating K (K is an integer of 2 or more and C or less) pieces of dye data indicating a distribution for each of K fluorescent dyes”.

The dye data acquisition method of the embodiment may be [2]“the dye data acquisition method according to [1], in which in the data acquisition step, the spectrum data that is the distribution of the intensity values for each of the C detection wavelengths is acquired by irradiating the target object with each of excitation light beams of a plurality of excitation wavelengths”.

The dye data acquisition method of the embodiment may be [3]“the dye data acquisition method according to [2], in which in the clustering step, the N target objects are clustered based on distribution information of the intensity values for each of the C detection wavelengths”.

The dye data acquisition method of the embodiment may be [4]“the dye data acquisition method according to any one of [1] to [3], in which in the calculation step, the statistical value is calculated based on an integrated value, a mode, or an intermediate value of the intensity values of the target object group”.

The dye data acquisition method of the embodiment may be [5]“the dye data acquisition method according to any one of [1] to [4], in which in the data generation step, a mixing matrix is obtained by using the statistical values of the C detection wavelengths for each of the L cluster matrices, and unmixing is performed by using the mixing matrix”.

The dye data acquisition method of the embodiment may be [6]“the dye data acquisition method according to [5], in which in the data generation step, a loss value is calculated based on the statistical values of the C detection wavelengths for each of the L cluster matrices by using nonnegative matrix factorization, and the mixing matrix is obtained based on a sum of the loss values”.

The dye data acquisition method of the embodiment may be [7]“the dye data acquisition method according to [6], in which in the data generation step, the loss value is corrected based on the statistical values for each of the L cluster matrices, and the mixing matrix is obtained based on a sum of the corrected loss values”.

The dye data acquisition method of the embodiment may be [8]“the dye data acquisition method according to any one of [1] to [7], in which in the clustering step, the C detection wavelengths are clustered into M (M is an integer of 2 or more and C−1 or less) detection wavelength groups based on the intensity values, for each of the N target objects, and M cluster matrices in which the intensity values for each of the N target objects are arranged for each clustered detection wavelength group are further generated”.

### REFERENCE SIGNS LIST

1 Dye data acquisition system
3, 3A Data acquisition device
Data processing device
201 Data acquisition unit
202 Clustering unit
203 Statistical value calculation unit
204 Matrix estimation unit
205 Data generation unit
A Mixing matrix

1: A dye data acquisition method, comprising:
acquiring spectrum data that is a distribution of fluorescence intensity values for each of C (C is an integer of 2 or more) detection wavelengths, for N (N is an integer of 2 or more) target objects;
clustering the N target objects into L (L is an integer of 2 or more and N−1 or less) target object groups based on the intensity values of each target object for each of the C detection wavelengths, and generating L cluster matrices in which the intensity values for each of the C detection wavelengths are arranged for each clustered target object group;
calculating a statistical value of the intensity values of the target object groups in the C detection wavelengths for each of the L cluster matrices; and
using the statistical values in the C detection wavelengths for each of the L cluster matrices to perform unmixing with respect to the C detection wavelengths, and generating K (K is an integer of 2 or more and C or less) pieces of dye data indicating a distribution for each of K fluorescent dyes.

2: The dye data acquisition method according to claim 1, wherein
in the acquiring,
the spectrum data that is the distribution of the intensity values for each of the C detection wavelengths is acquired by irradiating the target object with each of excitation light beams of a plurality of excitation wavelengths.

3: The dye data acquisition method according to claim 2, wherein
in the clustering, the N target objects are clustered based on distribution information of the intensity values for each of the C detection wavelengths.

4: The dye data acquisition method according to claim 1, wherein
in the calculating, the statistical value is calculated based on an integrated value, a mode, or an intermediate value of the intensity values of the target object group.

5: The dye data acquisition method according to claim 1, wherein
in the generating, a mixing matrix is obtained by using the statistical values of the C detection wavelengths for each of the L cluster matrices, and unmixing is performed by using the mixing matrix.

6: The dye data acquisition method according to claim 5, wherein
in the generating, a loss value is calculated based on the statistical values of the C detection wavelengths for each of the L cluster matrices by using nonnegative matrix factorization, and the mixing matrix is obtained based on a sum of the loss values.

7: The dye data acquisition method according to claim 6, wherein
in the generating, the loss value is corrected based on the statistical values for each of the L cluster matrices, and the mixing matrix is obtained based on a sum of the corrected loss values.

8: The dye data acquisition method according to claim 1, wherein
in the clustering,
the C detection wavelengths are clustered into M (M is an integer of 2 or more and C−1 or less) detection wavelength groups based on the intensity values, for each of the N target objects, and M cluster matrices in which the intensity values for each of the N target objects are arranged for each clustered detection wavelength group are further generated.

9: A dye data acquisition device that processes spectrum data that is a distribution of fluorescence intensity values for each of C (C is an integer of 2 or more) detection wavelengths, for N (N is an integer of 2 or more) target objects, wherein the dye data acquisition device is configured to:
cluster the N target objects into L (L is an integer of 2 or more and N−1 or less) target object groups based on the intensity values of each target object for each of the C detection wavelengths, and generate L cluster matrices in which the intensity values for each of the C detection wavelengths are arranged for each clustered target object group;
calculate a statistical value of the intensity values of the target object groups in the C detection wavelengths for each of the L cluster matrices; and
use the statistical values in the C detection wavelengths for each of the L cluster matrices to perform unmixing with respect to the C detection wavelengths, and generate K (K is an integer of 2 or more and C or less) pieces of dye data indicating a distribution for each of K fluorescent dyes.

10: The dye data acquisition device according to claim 9, further comprising:
a data acquisition device configured to acquire the spectrum data that is the distribution of the intensity values for each of the C detection wavelengths by irradiating the target object with each of excitation light beams of a plurality of excitation wavelengths.

11: A dye data acquisition program for generating dye data indicating a distribution of fluorescent dyes in N (N is an integer of 2 or more) target objects based on spectrum data that is a distribution of fluorescence intensity values for each of C (C is an integer of 2 or more) detection wavelengths, for the N target objects, the dye data acquisition program causing a computer to execute:
clustering the N target objects into L (L is an integer of 2 or more and N−1 or less) target object groups based on the intensity values of each target object for each of the C detection wavelengths, and generating L cluster matrices in which the intensity values for each of the C detection wavelengths are arranged for each clustered target object group;
calculating a statistical value of the intensity values of the target object groups in the C detection wavelengths for each of the L cluster matrices; and
using the statistical values in the C detection wavelengths for each of the L cluster matrices to perform unmixing with respect to the C detection wavelengths, and generating K (K is an integer of 2 or more and C or less) pieces of dye data indicating a distribution for each of K fluorescent dyes.

12: A dye data acquisition method, comprising:
acquiring spectrum data that is a distribution of fluorescence intensity values for each of C (C is an integer of 2 or more) detection wavelengths, for N (N is an integer of 2 or more) target objects;
clustering the C detection wavelengths into M (M is an integer of 2 or more and C−1 or less) detection wavelength groups based on the intensity values, for each of the N target objects, and generating M cluster matrices in which the intensity values for each of the N target objects are arranged for each clustered detection wavelength group;
calculating a statistical value of the intensity values of the detection wavelength groups in the N target objects for each of the M cluster matrices; and
using the statistical values in the N target objects for each of the M cluster matrices to perform unmixing with respect to the N target objects, and generating K (K is an integer of 2 or more and M or less) pieces of dye data indicating a distribution for each of K fluorescent dyes.

13: A dye data acquisition device that processes spectrum data that is a distribution of fluorescence intensity values for each of C (C is an integer of 2 or more) detection wavelengths, for N (N is an integer of 2 or more) target objects, wherein the dye data acquisition device is configured to:
cluster the C detection wavelengths into M (M is an integer of 2 or more and C−1 or less) detection wavelength groups based on the intensity values, for each of the N target objects, and generate M cluster matrices in which the intensity values for each of the N target objects are arranged for each clustered detection wavelength group;
calculate a statistical value of the intensity values of the detection wavelength groups in the N target objects for each of the M cluster matrices; and
use the statistical values in the N target objects for each of the M cluster matrices to perform unmixing with respect to the N target objects, and generate K (K is an integer of 2 or more and M or less) pieces of dye data indicating a distribution for each of K fluorescent dyes.

14: A dye data acquisition program for generating dye data indicating a distribution of fluorescent dyes in N (N is an integer of 2 or more) target objects based on spectrum data that is a distribution of fluorescence intensity values for each of C (C is an integer of 2 or more) detection wavelengths, for the N target objects, the dye data acquisition program causing a computer to execute:
clustering the C detection wavelengths into M (M is an integer of 2 or more and C−1 or less) detection wavelength groups based on the intensity values, for each of the N target objects, and generating M cluster matrices in which the intensity values for each of the N target objects are arranged for each clustered detection wavelength group;
calculating a statistical value of the intensity values of the detection wavelength groups in the N target objects for each of the M cluster matrices; and
using the statistical values in the N target objects for each of the M cluster matrices to perform unmixing with respect to the N target objects, and generating K (K is an integer of 2 or more and M or less) pieces of dye data indicating a distribution for each of K fluorescent dyes.
